(19) United States
(12) Patent Application Publication
(10) Pub. No.: US 2019/0093540 A1
(43) Pub. Date: Mar. 28, 2019

(54) SYSTEMS AND METHODS ADJUSTING FOR AFTERTREATMENT SYSTEM CONDITION

(71) Applicant: General Electric Company, Schenectady, NY (US)

(72) Inventors: Maruthi Narasinga Rao Devarakonda, Waukesha, WI (US); Monika Jonuskeviciute, Atlanta, GA (US)

(21) Appl. No.: 15/717,914

(22) Filed: Sep. 27, 2017

(51) Int. Cl. F01N 9/00; F01N 3/10

(52) U.S. Cl. CPC F01N 9/005; F02D 41/1458; F01N 3/101

(57) ABSTRACT

A system includes an aftertreatment system configured to treat emissions from an engine via a catalyst and a controller. The controller is configured to obtain one or more engine signals representative of operations of the engine and to execute a model to derive an estimated catalyst emission based on the one or more engine signals and on an expected catalyst degradation. The controller is further configured to obtain one or more catalyst signals representative of catalyst performance, and to generate an adaptation signal configured to improve accuracy of the model based on the one or more catalyst signals. The controller is also configured to apply the adaptation signal and the estimated catalyst emission to generate an engine control signal.

### BACKGROUND

The subject matter disclosed herein relates to power generation systems. Specifically, the embodiments described herein relate to adjusting for aftertreatment system condition within power generation systems.

Many power generation systems utilize an aftertreatment system to process the exhaust gases generated by the power generation system. In particular, aftertreatment systems may be used to reduce certain types of emissions by converting exhaust gases produced by the power generation system into other types of gases or liquids. For example, aftertreatment systems may be used to reduce the amount of nitrogen oxides within the exhaust gases. To reduce the amount of nitrogen oxides in the exhaust gases, an aftertreatment system may include one or more three-way catalyst (TWC) assemblies to reduce the emissions of nitrogen oxides (NOx), hydrocarbons (HC), carbon monoxide (CO), and other emissions. However, the effectiveness of the aftertreatment systems at reducing emissions may decrease over time.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes an aftertreatment system configured to treat emissions from an engine via a catalyst and a controller. The controller is configured to obtain one or more engine signals representative of operations of the engine and to execute a model to derive an estimated catalyst emission based on the one or more engine signals and on an expected catalyst degradation. The controller is further configured to obtain one or more catalyst signals representative of catalyst performance, and to generate an adaptation signal configured to improve accuracy of the model based on the one or more catalyst signals. The controller is also configured to apply the adaptation signal and the estimated catalyst emission to generate an engine control signal.

In a second embodiment, electronic control unit includes a processor operatively coupled to a memory. The processor is programmed to execute instructions on the memory to obtain one or more engine signals representative of operations of an engine, and to execute a model to derive an estimated catalyst emission based on the one or more engine signals and on an expected catalyst degradation. The processor is additionally programmed to execute instructions on the memory to obtain one or more catalyst signals representative of catalyst performance, and to generate an adaptation signal configured to improve accuracy of the model based on the one or more catalyst signals. The processor is additionally programmed to execute instructions on the memory to apply the adaptation signal and the estimated catalyst emission to generate an engine control signal.

In a third embodiment, One or more non-transitory computer-readable media storing one or more processor-executable instructions wherein the one or more instructions, when executed by a processor of a controller, cause acts to be performed. The acts to be performed include obtaining one or more engine signals representative of operations of an engine, and executing a model to derive an estimated catalyst emission based on the one or more engine signals and on an expected catalyst degradation. The acts to be performed additionally include obtaining one or more catalyst signals representative of catalyst performance, and generating an adaptation signal configured to improve accuracy of the model based on the one or more catalyst signals. The acts to be performed further include applying the adaptation signal and the estimated catalyst emission to generate an engine control signal.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic view of a power generation system having an aftertreatment system, in accordance with an embodiment;

FIG. 2 is a block diagram of a control system for the power generation system of FIG. 1, in accordance with an embodiment;

FIG. 3 is a schematic view of the aftertreatment system of the power generation system of FIG. 1, in accordance with an embodiment;

FIG. 4 is an information flow diagram of an embodiment of a process suitable for adaptation-based control for the engine and aftertreatment system of FIG. 1; and

FIG. 5 is a flowchart illustrating a process suitable for generating and adaptation adjustment signal, and for controlling the engine and aftertreatment system of FIG. 1 based on the adaptation adjustment signal, in accordance with an embodiments.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Many power generation systems (e.g., combustion engines, turbine engines) use an aftertreatment system to condition the exhaust gases generated by the power generation system. For instance, certain power generation systems utilize aftertreatment systems that are designed to reduce the amount of nitrogen oxides in the exhaust gases. These aftertreatment systems may include one or more catalyst systems, such as three-way catalyst (TWC) systems. A TWC system may utilize a one or more catalysts to convert pollutants, such as NOx, HC, CO, to less toxic emissions. Unfortunately, subjecting the TWC system to certain operating conditions over time often causes changes in the number and type of active sites reactions may occur on. The loss of active sites on the surface of the catalysts can result in a loss of conversion performance (i.e., how well the catalyst is operating). As catalyst conversion performance decreases, the emissions of pollutants (e.g., NOx, HC, CO, etc.) from the engine can exceed emission compliance values (e.g., thresholds or requirements). By creating a “digital twin” that mirrors the behavior and performance of a specific TWC system, the techniques described herein may adapting the air-fuel ratio controls of the engine based on the catalyst performance, the engine can remain in emissions compliance for a longer duration of time than if the air-fuel ratio controls were not adapted based on catalyst performance.

The disclosed embodiments include accounting for or obtaining one or more operating parameters of a combustion engine that may indicate a catalyst health for the TWC system. The operating parameters may include any actual or estimated aspects of the power production system performance suitable for indicating the performance of the catalysts, such as time (e.g., engine run time, catalyst aging time, times at different engine temperatures, etc.), temperatures, flow rates, and/or emission measurements. The catalyst health may describe how well the catalyst is performing at converting pollutants to less harmful emissions. Catalyst health may be monitored as a function of O2 storage and other species emissions measured at locations post-catalyst in real time, as a part of a diagnostics module.

Once a discrepancy is recorded in the diagnostics module, an adaptation module may be activated. The adaptation module may take into account an operating time and actual behavior of the TWC system, e.g., providing features of a “digital twin” of the TWC, and a new oxygen storage set-point may be provided. The new oxygen storage set-point may be applied by controller embodiments to better accommodate an active site loss. The new oxygen storage set-point may be obtained through an online optimization-solving process that minimizes a model error in a target NOx and in a target CO emissions at post-catalyst locations, as described in more detail below. Engine control via the new set-point may then provide for improved engine operations because an adjusted set-point may reflect or more closely model actual health and/or performance for the specific TWC system being controlled. Accordingly, air-fuel ratio control of the engine, for example, may be more accurately provided.

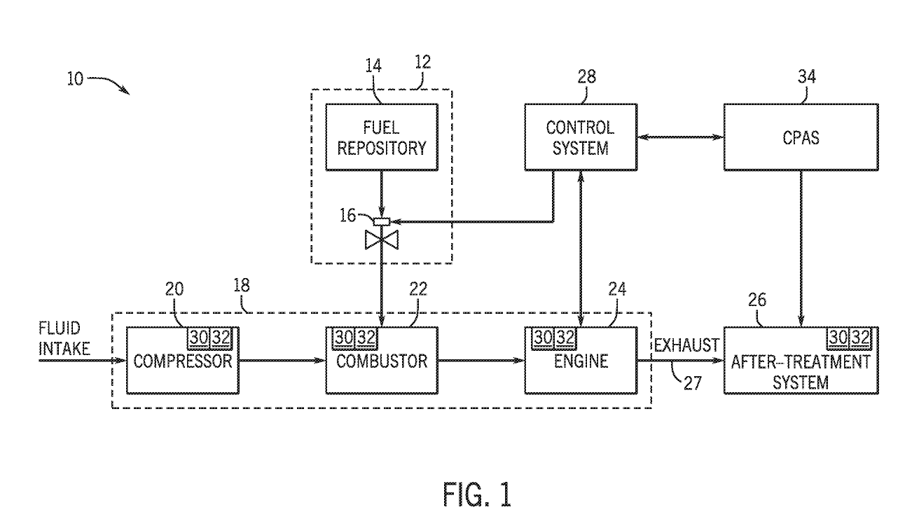

With the foregoing in mind, FIG. 1 depicts a power generation system 10 that may be used to provide power to a load, such as an electric generator, a mechanical load, and the like. The power generation system 10 includes a fuel supply system 12, which in turn includes a fuel repository 14 and a throttle 16 that controls the fuel flow from the fuel repository 14 and into the power generation system 10. The power generation system 10 also includes an engine system 18 which includes a compressor 20, a combustor 22, and a gas engine 24. Exemplary engine systems 18 may include General Electric Company's Jenbacher Engines (e.g., Jenbacher Type 2, Type 3, Type 4, Type 6 or J920 FleXtra) or Waukesha Engines (e.g., Waukesha VGF, VHP, APG, 275GL), for example. Further, the power generation system 10 includes an aftertreatment system 26, which is described in further detail below.

The power generation system 10 also includes a control system 28 which monitors various aspects of the operation of the power generation system 10. In particular, the control system 28 may work in conjunction with sensors 30 and actuators 32 to monitor and adjust the operation of the power generation system 10. For instance, various types of sensors 30, such as temperature sensors, oxygen sensors, fluid flow sensors, mass flow sensors, fluid composition sensors, and/or pressure sensors may be disposed on or in the components of the power generation system 10, and the throttle 16 is a specific actuator 32. Although the power generation system 10 is described as a gas engine system, it should be appreciated that other types of power generation systems (e.g., gas turbines, cold-day systems, combined cycle systems, co-generation systems, etc.) may be used and include the control system 28, aftertreatment system 26.

During operation, the fuel supply system 12 may provide fuel to the engine system 18 and, specifically, the combustor 22, via the throttle 16. Concurrently, the compressor 20 may intake a fluid (e.g., air or other oxidant), which may be compressed before it is sent to the combustor 22. Within the combustor 22, the received fuel mixes with the compressed fluid to create a fluid-fuel mixture which then combusts before flowing into the gas engine 24. The combusted fluid-fuel mixture drives the gas engine 24, which in turn produces power for suitable for driving a load. For example, the gas engine 24 may in turn drive a shaft connected to the load, such as a generator for producing energy. It is to be understood that the gas engine 24 may include internal combustion engines, gas turbine engines, and the like.

The combustion gases produced by the gas engine 24 exit the engine and vent as exhaust gases 27 into the aftertreatment system 26. In present embodiments, the exhaust gases 27 pass through one or more catalytic converter systems, which will be described in further detail below. In some embodiments, the exhaust gases 27 may also pass through a heat recovery steam generator (HRSG), which may recover the heat from the exhaust gases to produce steam. To monitor and adjust the performance of the aftertreatment system 26, the power generation system 10 includes a catalytic performance and adaptation system (CPAS) 34, which is described in further detail below. In certain embodiments, the CPAS 34 may be included as part of the control system 38. For example, as software stored in memory and executable via one or more processors. In other embodiments, the CPAS 34 may be a stand-alone system communicatively coupled to the control system 28.

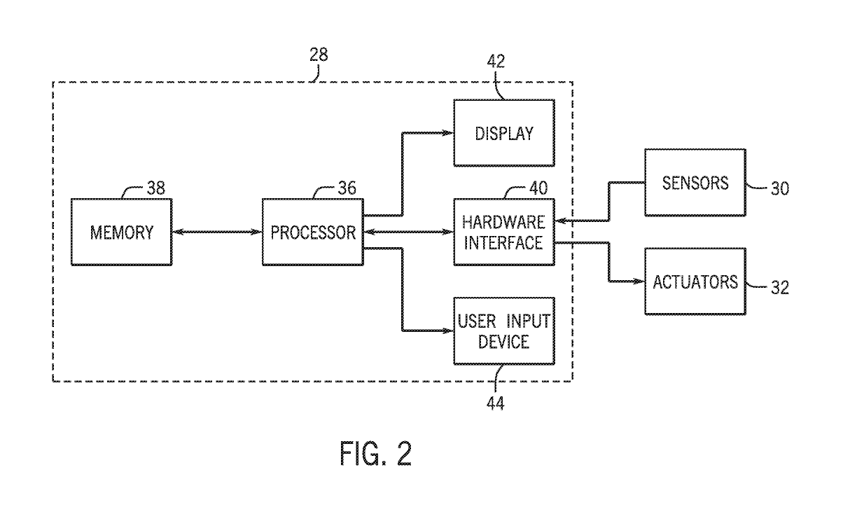

As mentioned earlier, the control system 28 (e.g., engine control unit [ECU]) oversees the operation of the power generation system 10. The control system 28 includes a processor 36, memory 38, and a hardware interface 40, as shown in FIG. 2. As depicted, the processor 36 and/or other data processing circuitry may be operably coupled to memory 38 to retrieve and execute instructions for managing the power generation system 10. For example, these instructions may be encoded in programs that are stored in memory 38, and the memory 38 may be an example of a tangible, non-transitory computer-readable medium. The instructions or code may be accessed and executed by the processor 36 to allow for the presently disclosed techniques to be executed. The memory 38 may be a mass storage device, a FLASH memory device, removable memory, or any other non-transitory computer-readable medium suitable for storing executable instructions or code. Additionally and/or alternatively, the instructions may be stored in an additional suitable article of manufacture that includes at least one tangible, non-transitory computer-readable medium that at least collectively stores these instructions or routines in a manner similar to the memory 38 as described above. The control system 28 may also communicate with the sensors 30 and the actuators 32 via the hardware interface 40. In some embodiments, the control system 28 may also include a display 42 and a user input device 44 to allow an operator to interact with the control system 28.

In some embodiments, the control system 28 may be a distributed control system (DCS) or similar multiple controller systems, such that each component (e.g., gas engine 24, aftertreatment system 26, urea injection control system 34) or group of components in the power generation system 10 includes or is associated with a controller for controlling the specific component(s). In these embodiments, each controller includes a processor, memory, and a hardware interface similar to the processor 36, the memory 38, and the hardware interface 40 described above. Each controller may also include a communicative link to communicate with the other controllers.

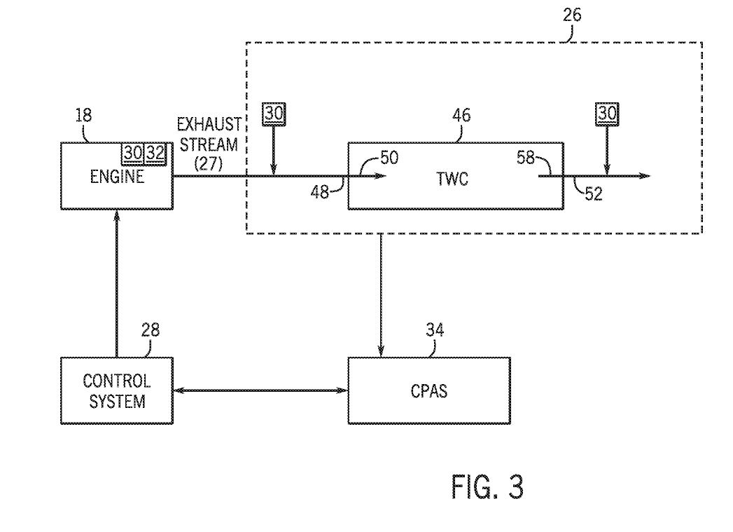

Turning now to FIG. 3, the figure is a block diagram of certain embodiments of components of the aftertreatment system 26, including a three-way catalyst (TWC) system 46 that receives and conditions the exhaust gas stream 27 exiting the gas engine 24. Because FIG. 3 includes like elements to FIGS. 1 and 2, the like elements are depicted with like numbers. Although the depicted embodiment depicts a single TWC system 46, it should be appreciated that the aftertreatment system 26 may include more than one TWC system 46 and/or any type of NOx reduction catalyst, as well as other catalytic converter systems and other components, such as the HRSG mentioned above. With the TWC system 46 fluidly coupled to the engine 18, the engine 18 may operate as a rich-burn engine or a lean-burn engine depending on the mass ratio of air to fuel (AFR). In certain embodiments, the engine 18 may be operated as a rich-burn engine (e.g., equivalence ratio (i.e., ratio of actual AFR to stoichiometric AFR), or lambda (λ) value oscillating around 1 (e.g., stoichiometric engine)) to maximize the catalytic activity in the TWC system 46.

The TWC system 46 is a particular type of exhaust catalyst used to convert nitrogen oxides into diatomic nitrogen (N₂), carbon dioxide (CO₂) and water. In addition to being used in the gas engine system 24, TWC system 46 may also be used in utility boilers, industrial boilers, municipal solid waste boilers, diesel engines, diesel locomotives, gas turbines, and automobiles. The exhaust stream 27 may enter the TWC system 46 at an inlet 48. Before entering the TWC system 46, one or more sensors 30 may be used to determine certain properties of the exhaust stream 27, such as chemical composition, temperature, flow rate, pressure, and so on. In certain embodiment, the sensors 30 may include lambda sensors suitable for measuring a proportion of oxygen (02) in the exhaust stream 27.

The exhaust stream 27 may then as stream 50. The TWC system 46 may include honeycomb structures having a washcloth of certain platinum group metal(s) (PGM) such as platinum and/or rhodium, as well as ceria (cerium oxide). The TWC system 46 may convert NOx into N₂ and CO₂. For example, a reaction NO+CO→N₂+CO₂ may be provided by the TWC system 46, as well as other reactions. For example, CO+0.5O₂→CO₂ and a reaction C₃H₆+4.5O₂→3CO₂+3H₂O may be provided by the TWC system 46. An exhaust stream 52 substantially devoid of NOx may then exit the TWC system 46 at outlet 58.

The exhaust stream 52 may include substantially reduced levels of NOx, CO, and HC. The TWC system 46 includes “three-way” in its name because it is suitable for removing three types of pollutants, e.g., NOx, CO, and hydrocarbons. After exiting the TWC system 46, another sensor 30 may be used to determine certain properties of the exhaust stream 52, such as chemical composition, temperature, flow rate, pressure, and so on. In certain embodiment, the post-TWC system 46 sensors 30 may include lambda sensors suitable for measuring a proportion of oxygen (02) in the exhaust stream 52. The exhaust stream 52 may then be released to ambient or be further processed by other component of the aftertreatment system 26. For example, other catalytic systems such as reduction catalysts, oxidation catalysts, and so on, may process the exhaust stream 52.

The sensors 30 and components of the aftertreatment system 26 may be communicatively coupled to the CPAS 34. As stated above, the CPAS system 34 may monitor the performance and the ongoing life of the aftertreatment system 26. In particular, the CPAS 34 may determine one or more adaptive adjustments and collaborate with the control system 28 to improve engine 18 control by applying the adaptive adjustments during operations of the engine 18, as further described below. Further, the CPAS 34 may prompt diagnostic evaluations of and certain action (e.g., alarms, alerts, corrective actions) for the aftertreatment system 26.

The CPAS 34, as shown in FIG. 3, may be separate from the control system 28, and may contain a processor, memory, and a hardware interface similar to those of the control system 28. In other embodiments, the CPAS 34 may be part of the control system 28. For example, the CPAS 34 may reside in one of multiple controllers within a distributed control system, as described above, or may be provided as computer instructions executable via the control system 28.

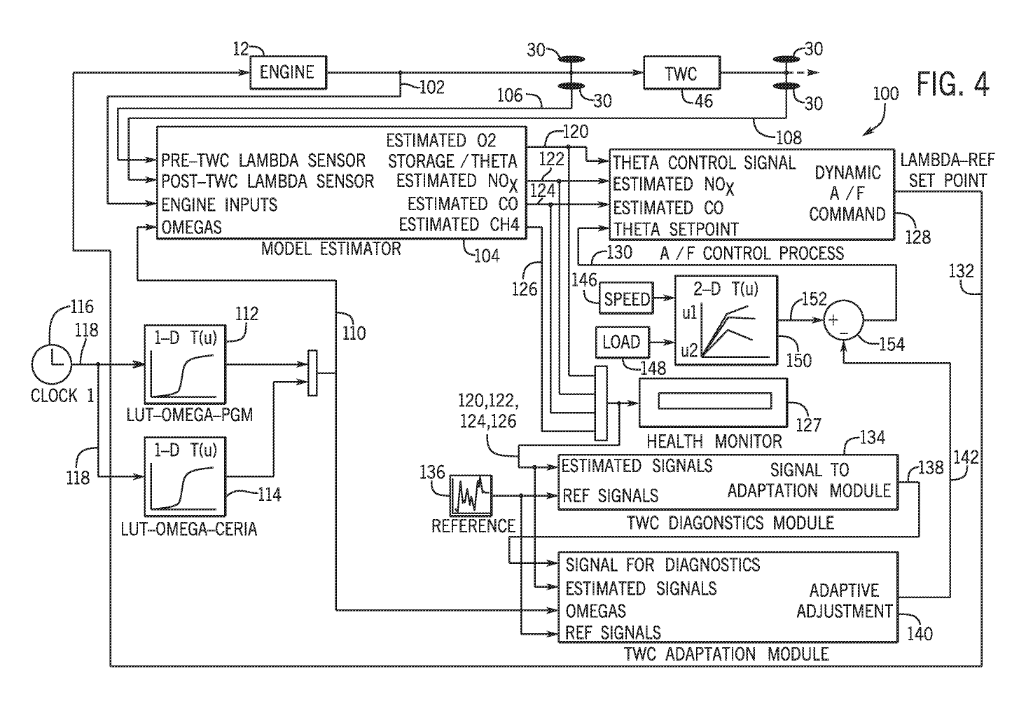

FIG. 4 is an information flow diagram of embodiments of a process 100 suitable for adaptation-based control for the engine 18 of FIG. 1. The process 100 may be executed by the control system 28 and/or the CPAS 34 (e.g., utilizing the processor 36 to execute programs and access data stored on the memory 38). Because FIG. 4 includes like elements to FIGS. 1-3, the like elements are depicted with like numbers.

In the depicted embodiment, engine parameters 102 may be sensed during engine 18 operations, for example via the sensors 30 and provided to a model estimator 104. Likewise, pre-catalyst measurements 106 and post-catalyst measurements 108 may the communicated to the model estimator 104. Additionally, omega parameters 110 may be derived, for example, via lookup tables (LUT) LUT_Omega PGM 112 and LUT_Omega Ceria 114. More specifically, to account for aging of the TWC system 46, a clock 116 may be utilized to provide an amount of time 118 (e.g., how long the TWC system 46 has been operating) based on clock cycles as counted by, for example, the processor 36. The omega parameter PGM derived via the LUT 112 may indicate how certain metals, such as PGM metals in the TWC system 46, age or degrade over time. As such, the omega parameter derived via the LUT 112 may provide a PGM deterioration factor that indicates how much the TWC system 46 has deteriorated (e.g., due to aging) based at least in part on one or more operating parameters, such as the time (e.g., from clock 116) and/or a component of the TWC system 46.

The omega parameter ceria 110 derived via the LUT 114 may indicate how ceria in the TWC system 46 ages or degrades over time. Accordingly, the ceria parameter 110 derived via the LUT 114 may provide for a ceria deterioration factor that indicates how much the TWC system 46 has deteriorated based on ceria aging and or loading. The PGM and ceria omega parameters, i.e., parameters 110, may then be processed by the model estimator 104. The model estimator 104 may use the parameters 102, 106, 108, and/or 110 as input to derive an estimated O₂ storage (theta) 120, an estimated NOx emissions 122, an estimated CO emissions 124, and estimated CH₄ emission (or other hydrocarbons emissions) 126. The model estimator 104 may include one or more physics-based models, such as chemical models, fluid dynamics models, and the like, that model the behavior of the exhaust streams 48, 52, and/or 58 as processed by the TWC system 46.

The estimated O₂ storage 120 and estimated emissions 122, 124, 126 may be monitored by a health monitor system 127. For example, the health monitor system 127 may display the estimated O₂ storage 120 and estimated emissions 122, 124, 126 for a user to view, and may additionally log the estimated O₂ storage 120 and estimated emissions 122, 124, 126. The estimated O₂ storage 120 and estimated emissions 122, 124, 126 may also be communicated to an air/fuel (AF) control process 128. The AF control process 128 may additionally receive an adjusted theta set-point 130, as further described below. The AF control process 128 may then apply the estimated O₂ storage 120, emissions 122, 124, 126, and adjusted theta set-point 130 to derive a dynamic AF command, such as a lambda reference set-point 132. The lambda reference set-point 132 may then be used to control the engine 18, for example, by adjusting oxidant (e.g., air) intake, adjusting fuel throttle position, and so on, to meet a desired AFR. The lambda may be measured via lambda-type or oxygen concentration-type sensors 30, such via the measurements 106, 108.

To derive the adjusted theta set-point 130, the process 100 may apply the estimated O₂ storage 120 and estimated emissions 122, 124, 126 to a TWC diagnostics module 134. The TWC diagnostics module 134 may include a set of reference signals 136, or be communicated the set of reference signals 136. The set of reference signals 136 may be used to diagnose the TWC systems, and may include an O₂ storage reference signal, a NOx emissions reference signal, a CO emissions reference signal, a CH₄ emissions reference signal, or a combination thereof. The reference signals 136 may be derived, for example, by observing a fleet of TWC systems 46 and deriving the reference signals 136 based on observed measurements (e.g., O₂ storage, NOx emissions, CO emissions, CH₄ emissions) as the TWC systems operate with different fuels, levels of oxidant (e.g., air), and/or throttle positions, and degrade over time. Additionally or alternatively, the reference signals 136 may be based on modeling, e.g., physics-based modeling, of the TWC systems 46.

In one embodiment, each of the O₂ storage 120 and/or estimated emissions 122, 124, 126 may be compared to one or more of the reference signals 136, and if the O₂ storage 120 and/or estimated emissions 122, 124, 126 is outside a desired range or value, the TWC diagnostics module 134 may communicate a signal 138 to a TWC adaption module 140. The TWC adaptation module 140 may use the signal 138 and/or a time-based trigger (e.g., starting execution of the TWC adaptation module 140 after a certain elapsed catalyst operation time of TWC system 46 and/or engine 18 exceeds a desired time value, such as after operations of the TWC system 46 and/or the engine 18 have exceeded a time of between 10-10000 hours). In operations, the TWC adaptation module may apply as inputs the O₂ storage 120 and estimated emissions 122, 124, 126, the omega parameters 110 (e.g., ceria and/or PGM parameters found via LUTs 112, 114), and the reference signals 136 to derive an adaptive adjustment signal 142.

The adaptive adjustment signal 142 may be derived, for example, by applying techniques that correct for or minimize errors in the model estimator 104. In one embodiment, a theta (e.g., oxygen storage) set-point Θₛₚ is identified or derived by a real-time optimization or minimization of J=f(e_{NO}_{ₓ},e_{CO}) where J is a function of a NOx error (e.g., e_{NO}_{ₓ}) and a CO error (e.g., e_{CO}) measured via post-TWC system 46. That is, sensors 30 disposed downstream of the TWC system 46 may measure the exhaust stream 56 for NOx and CO concentrations, and based on this measure, compare the actual NOx and CO concentrations with the estimated NOx 122 and the estimated CO 124 to find the errors e_{NO}_{ₓ} and e_{CO}. Absolute value differences (e.g., errors e_{NO}_{ₓ} and e_{CO}) between the measured NOx and CO concentrations and the estimated NOx 122 and the estimated CO 124 may then be used to identify the theta set-point Θₛₚ that may minimize or eliminate such differences, e.g., bring the errors to zero or close to zero. The real-time optimization may include techniques such as algebraic sum of errors (e.g., algebraic sum of the errors e_{NO}_{ₓ} and e_{CO}), sum of root mean square estimate of errors e_{NO}_{ₓ} and e_{CO}, or a combination thereof.

The process 100 may apply an engine speed 146 and a load 148 as inputs to a lookup table (LUT) 150. The LUT 150 may be a 2-dimensional LUT that is maps speed and load to a theta set-point. Accordingly, the inputted speed 146 and load 148 may be processed by the LUT 150 to result in an un-adjusted theta set-point 152. The un-adjusted theta set-point 152 may be adjusted via the adaptive signal 142 by an adjustment module 154 to derive the adjusted theta set-point 130 based on the desired theta set-point Θₛₚ. Accordingly, the adjusted theta set-point 130 may minimize or eliminate model estimator 104 errors, and the resulting lambda reference set-point 132 may more accurately control the engine 18, and remain in remain in emissions compliance for an extended duration of time.

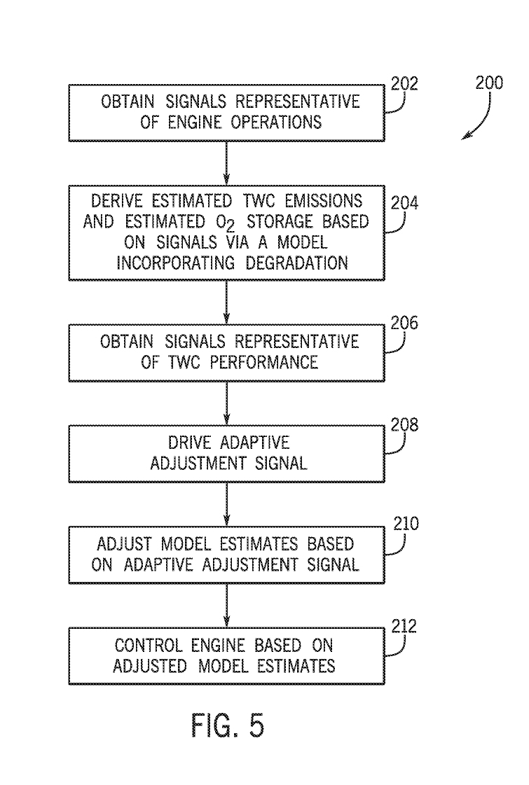

FIG. 5 is a flowchart of an embodiment of a process 200 suitable for generating the adaptation adjustment signal 142 shown in FIG. 4, and controlling the engine 18 based on the adaptation adjustment signal 142. The process 200 may be implemented as computer code or instructions stored in the memory 38 and executable via the processor 36. In the depicted embodiment, the process 200 may obtain (block 202) signals representative of engine operations, such as signals 102, 106. The process 200 may then derive (block 204) via the model estimator 104 one or more estimated TWC emissions 122, 124, 126 as well as derive (block 204) the estimated O₂ storage 120. The derivations (block 204) may incorporate TWC degradation factors, such as by applying the LUT 112 and LUT 114 to derive PGM and/or ceria degradation factors.

The process 200 may then obtain (block 206) one or more signals representative of performance of the TWC system 46, such as signals 108. The adaptive adjustment signal 142 may then be derived (block 208). In one embodiment, the adaptive adjustment signal 142 may be derived by identifying the theta (e.g., oxygen storage) set-point Θₛₚ that may minimize modeling errors (e.g., errors from the model estimator 104), and may also incorporate the degradation parameters 110. Accordingly, in one embodiment, the process 200 may minimize the function J=f(e_{NO}_{ₓ}, e_{CO}) where J is a function of the exhaust NOx (e.g., e_{NO}_{ₓ}) and exhaust CO (e.g. e_{CO}). The adaptive adjustment signal 142 may be derived (block 208) based on time, e.g., such as after a desired operating time for the TWC system 46 and/or the engine 18. The adaptive adjustment signal 142 may additionally or alternatively be derived (block 208) based on the signal 138 transmitted via the TWC diagnostic module 134.

The process 200 may then adjust (block 210) model estimates such as the adjusted theta set-point 130. To adjust (block 210) the adjusted theta set-point 130, the process 200 may apply the adaptive adjustment signal 142 to the un-adjusted theta set-point 152 to derive the adjusted theta set-point 130. The un-adjusted theta set-point 152 may be derived by applying speed 146 and load 148 to the LUT 150 mapping speed and load to a desired theta. The process 200 may then control (block 212) the engine 18, for example by applying the adjusted model estimates to adjust oxidant (e.g., air) intake, adjust fuel throttle position, and so on, based on the lambda reference set-point 132. By adapting engine control to more closely model the behavior of the TWC system 46 and engine 18, the techniques described herein may improve engine control and increase emissions compliance.

Technical effects of the invention include monitoring and adjusting the operation of an aftertreatment system and/or an engine of a power generation system. Certain embodiments enable adjusting operating set-points of the engine based on degradation and based on actual aftertreatment system and engine performance to improve the control and operations of the engine and the aftertreatment system. For instance, a theta set-point may be adjusted based both modeled degradation as well as actual performance of the aftertreatment system and the engine. The adjusted theta set-point may then be used to control operations of the engine.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
an aftertreatment system configured to treat emissions from an engine via a catalyst; and
a controller configured to:
obtain one or more engine signals representative of operations of the engine;
execute a model to derive an estimated catalyst emission based on the one or more engine signals and on an expected catalyst degradation;
obtain one or more catalyst signals representative of catalyst performance;
generate an adaptation signal configured to improve accuracy of the model based on the one or more catalyst signals; and
apply the adaptation signal and the estimated catalyst emission to generate an engine control signal.

2. The system of claim 1, wherein the controller is configured to analyze a difference between a reference signal and the estimated catalyst emission and to generate the adaptation signal based on the difference.

3. The system of claim 2, wherein the reference signal comprises an O₂ storage reference signal, a NOx emissions reference signal, a CO emissions reference signal, a CH₄ emissions reference signal, or a combination thereof.

4. The system of claim 1, wherein the controller is configured to execute the model to derive an estimated O₂ catalyst storage based on the one or more engine signals and on the expected catalyst degradation, and wherein the controller is configured to apply the estimated O₂ catalyst storage, the adaptation signal, and the estimated catalyst emission to generate the engine control signal.

5. The system of claim 1, wherein the controller is configured to derive the expected catalyst degradation based on applying an elapsed catalyst operation time to a platinum group metal (PGM) lookup table, to a Ceria lookup table, or to a combination thereof.

6. The system of claim 1, wherein the controller is configured to apply the adaptation signal to derive a corrected theta set-point, and wherein the controller is configured to apply the corrected theta set-point, the adaptation signal and the estimated catalyst emission to generate the engine control signal.

7. The system of claim 6, wherein the engine control signal comprises a lambda reference set-point representative of a desired mass ratio of air to fuel (AFR).

8. The system of claim 1, wherein the controller is configured to generate the adaptation signal by deriving a desired theta set-point based on a real-time optimization of a function J=f(e_{NO}_{ₓ},e_{CO}) where e_{NO}_{ₓ} is a nitrogen oxide (NOx) error derived by computing a first absolute difference between an estimated NOx emission derived via the model and a measured NOx emission sensed from a NOx sensor disposed downstream of the catalyst, and e_{CO} is a carbon monoxide (CO) error derived by computing a second absolute difference between an estimated CO emission derived via the model and a measured CO emission sensed from a CO sensor disposed downstream of the catalyst, and wherein the real-time optimization comprises an algebraic sum of errors, a sum of root mean square estimate of errors, or a combination thereof.

9. The system of claim 1 wherein the catalyst comprises a three-way catalyst (TWC) system.

10. An electronic control unit, comprising:
a processor operatively coupled to a memory, wherein the processor is programmed to execute instructions on the memory to:
obtain one or more engine signals representative of operations of an engine;
execute a model to derive an estimated catalyst emission based on the one or more engine signals and on an expected catalyst degradation;
obtain one or more catalyst signals representative of catalyst performance;
generate an adaptation signal configured to improve accuracy of the model based on the one or more catalyst signals; and
apply the adaptation signal and the estimated catalyst emission to generate an engine control signal.

11. The electronic control unit of claim 10, wherein the processor is programmed to execute instructions on the memory to analyze a difference between a reference signal and the estimated catalyst emission and to generate the adaptation signal based on the difference.

12. The electronic control unit of claim 10, wherein the processor is programmed to execute instructions on the memory to execute the model to derive an estimated O₂ catalyst storage based on the one or more engine signals and on the expected catalyst degradation, and wherein the controller is configured to apply the estimated O₂ catalyst storage, the adaptation signal, and the estimated catalyst emission to generate the engine control signal.

13. The electronic control unit of claim 10, wherein the processor is programmed to execute instructions on the memory to derive the expected catalyst degradation based on applying an elapsed catalyst operation time to a platinum group metal (PGM) lookup table, to a Ceria lookup table, or to a combination thereof.

14. The electronic control unit of claim 10, wherein the processor is programmed to execute instructions on the memory to generate the adaptation signal by deriving a desired theta set-point based on a real-time optimization of a function J=f(e_{NO}_{ₓ},e_{CO}) where e_{NO}_{ₓ} is a nitrogen oxide (NOx) error derived by computing a first absolute difference between an estimated NOx emission derived via the model and a measured NOx emission sensed from a NOx sensor disposed downstream of the catalyst, and e_{CO} is a carbon monoxide (CO) error derived by computing a second absolute difference between an estimated CO emission derived via the model and a measured CO emission sensed from a CO sensor disposed downstream of the catalyst, and wherein the real-time optimization comprises an algebraic sum of errors, a sum of root mean square estimate of errors, or a combination thereof.

15. One or more non-transitory computer-readable media storing one or more processor-executable instructions wherein the one or more instructions, when executed by a processor of a controller, cause acts to be performed comprising:
obtaining one or more engine signals representative of operations of an engine;
executing a model to derive an estimated catalyst emission based on the one or more engine signals and on an expected catalyst degradation;
obtaining one or more catalyst signals representative of catalyst performance;
generating an adaptation signal configured to improve accuracy of the model based on the one or more catalyst signals; and
applying the adaptation signal and the estimated catalyst emission to generate an engine control signal.

16. The non-transitory computer readable medium of claim 15, wherein the acts to be performed comprise analyzing a difference between a reference signal and the estimated catalyst emission and to generate the adaptation signal based on the difference.

17. The non-transitory computer readable medium of claim 15, wherein the acts to be performed comprise generate the adaptation signal after an elapsed catalyst operation time exceeds an operating time value.

18. The non-transitory computer readable medium of claim 15, wherein the acts to be performed comprise executing the model to derive an estimated O₂ catalyst storage based on the one or more engine signals and on the expected catalyst degradation, and wherein the controller is configured to apply the estimated O₂ catalyst storage, the adaptation signal, and the estimated catalyst emission to generate the engine control signal.

19. The non-transitory computer readable medium of claim 15, wherein the acts to be performed comprise deriving the expected catalyst degradation based on applying an elapsed catalyst operation time to a platinum group metal (PGM) lookup table, to a Ceria lookup table, or to a combination thereof.

20. The non-transitory computer readable medium of claim 15, wherein the acts to be performed comprise generating the adaptation signal by deriving a desired theta set-point based on a real-time optimization of a function J=f(e_{NO}_{ₓ},e_{CO}) where e_{NO}_{ₓ} is a nitrogen oxide (NOx) error derived by computing a first absolute difference between an estimated NOx emission derived via the model and a measured NOx emission sensed from a NOx sensor disposed downstream of the catalyst, and e_{CO} is a carbon monoxide (CO) error derived by computing a second absolute difference between an estimated CO emission derived via the model and a measured CO emission sensed from a CO sensor disposed downstream of the catalyst, and wherein the real-time optimization comprises an algebraic sum of errors, a sum of root mean square estimate of errors, or a combination thereof.
